(19) United States
(12) Patent Application Publication
(10) Pub. No.: US 2007/0288397 A1
(43) Pub. Date: Dec. 13, 2007

(54) Methodology for robust portfolio evaluation and optimization taking account of estimation errors

(75) Inventors: Gabriel Frahm, Koeigswinter (DE); Uwe Jaekel, Eitorf (DE)

Correspondence Address: SUGHRUE MION, PLLC, 2100 PENNSYLVANIA AVENUE, N.W., SUITE 800, WASHINGTON, DC, 20037, US

(73) Assignee: NEC Europe Ltd.

(21) Appl. No.: 11/450,385

(22) Filed: Jun. 12, 2006

(51) Int. Cl. G06Q 40/00

(52) U.S. Cl. 705/36 R

(57) ABSTRACT

The present invention relates to a portfolio evaluation and optimization in the presence of estimation errors. The method for optimizing a portfolio with several financial instruments, comprises steps of: selecting constraints and optimality criteria for the portfolio; obtaining historical information for financial risk factors and selecting an appropriate model for simulating the risk factors of the portfolio by way of a generalized elliptical distribution. Similarly, the method for evaluating a portfolio with several financial instruments, comprises steps of: selecting evaluation criteria for the portfolio; obtaining historical information for financial risk factors and selecting an appropriate model for simulating the risk factors of the portfolio by way of a generalized elliptical distribution. The model selection is based on historical information. According to the present invention both estimation risk and market risk are considered by simulation. The risk factors are simulated by drawing parameters and paths given the above appropriate model and the observations. It is a preferable advantage of the present invention that historical data may contain missing values. Another preferable advantage of the present invention is that portfolio evaluation and optimization is possible for long-term investments with arbitrary financial instruments. The optimal portfolio strategy is determined by considering the selected constraints and the optimality criteria on the basis of the parameters and paths simulated.

### FIELD OF THE INVENTION

The present invention relates to a portfolio evaluation and optimization in the presence of estimation errors. In particular, the method of the present invention provides a robust portfolio evaluation and optimization even for long investment horizons.

### BACKGROUND OF THE INVENTION

Portfolio managers seek to maximize the return on an overall investment of funds for a given level of risk as for example defined in terms of variance of return. Modern portfolio theory (MPT) proposes how investors shall use diversification to optimize their portfolios. The portfolio risk can be reduced by holding unrelated assets or instruments, i.e. the correlation between the returns of the individual instruments is small or even negative. MPT models the return of an asset as a random variable and a portfolio as a weighted combination of assets; the return of a portfolio is thus also a random variable and consequently has an expected value and a variance. Risk in this models is typically identified with the standard deviation of portfolio return, i.e. the square root of the variance. Typically, an investor choosing between several portfolios with identical expected returns will prefer the portfolio that minimizes risk for a given level of expected return. The underlying assumption of MPT is that investors are risk averse. This means that given two assets or two portfolios that offer the same return, investors will prefer the less risky one. Thus, an investor will take an increased risk only if compensated by higher expected returns. Conversely, an investor who wants higher returns must accept more risk. The value of acceptable risk will differ by investor.

The expected return (or value) of a portfolio can either be calculated in a discrete or continuous manner. The discrete return R of a portfolio P after the time period 0 to T is given by

$${R}_{0 , T}^{( P )} := \frac{{P}_{T}}{{P}_{0}} - 1 = {\prod }_{t = 0}^{T - 1} ( 1 + {w}_{t}^{′} {R}_{t , t + 1} ) - 1 , \qquad ( 1 )$$

with P_{T} as the price of the portfolio at the end of the time period T and the price P₀ at the beginning of the time period. Further, the vector R_{t,t+1}=(R_{t,t+1}⁽¹⁾, . . . , R_{t,t+1}^{(d)}) consists of the individual asset returns. Here the prime symbol denotes transposition and thus w′ₜR_{t,t+1} is the weighted sum of the returns of the individual assets and corresponds to the portfolio return after the time interval [t,t+1].

In contrast the continuous or ‘log-return’ of a portfolio is calculated by

L_{0,T}^{(P)}:=log(P_{T})−log(P₀). (2)

The individual log-return for each underlying asset of the portfolio which comprises d assets can be written as

L_{t,t+1}⁽ⁱ⁾:=log(P_{i,t+1})−log(P_{i,t}), i=1, . . . , d. (3)

The other way round, a stock price can be calculated by a known return as

P_{i,t+1}=P_{i,t}exp(L_{t,t+1}ⁱ). (4)

Moreover, the log-return comprises the following advantageous feature:

$${L}_{0 , T}^{( i )} = {\sum }_{t = 0}^{T - 1} ( log ( {P}_{i , t + 1} ) - log ( {P}_{i , t} ) ) = {\sum }_{t = 0}^{T - 1} {L}_{t , t + 1}^{( i )} . \qquad ( 5 )$$

Investment managers typically think in terms of discrete returns. MPT is based on the model assumption that discrete returns are normally distributed, which is problematic for long investment horizons due to skewed or asymmetric distributions or negative portfolio values. Log-returns are less problematic for the model assumption of normally distributed returns. With regard to Eq. (5) the log-return of a stock can be modeled as a sum of independent and identically distributed increments. However, log-returns do not provide the advantageous linear relationship between individual and portfolio returns of Eq. (1).

In standard portfolio theory, it is assumed that investor's risk/reward preference can be described via a function which depends only on the expected return, i.e. mean return (μ), and the volatility or the risk, i.e. the standard deviation (σ). Known prior art models are based on the assumption that the mean return (μ) and (σ) are well known. Moreover, according to known prior art models it is assumed that the return is normally distributed. The normal distribution is characterized completely by its mean and its variance, such that under this assumption the investor is indifferent to other characteristics of the distribution such as its skew.

Asset returns traditionally have been modelled by methods based on the normal distribution assumption. However, asset returns typically are not independent and do not follow a Gaussian distribution. The absolute value of returns often show long ranged and slowly decaying autocorrelations and the return distribution has a sharper peak and fatter tails than that of the Gaussian. These are well known stylized facts of empirical finance. The stylized facts are particularly noticeable in short term distributions, such as the distribution of daily returns. In spite of these facts, the shape of the distribution approaches the normal distribution with a growing time interval. Hence long-term log-returns such as quarterly returns are approximately normally distributed.

According to MPT every possible asset combination can be plotted in a risk-return space, and the collection of all such possible portfolios defines a region in this space. The line along the upper edge of this region is known as the mean-variance (MV) efficient frontier. Combinations along this line represent portfolios for which there is lowest risk for a given level of expected return. Conversely, for a given amount of risk, the portfolio lying on the efficient frontier represents the combination offering the best possible expected return. However, in the model of Markowitz it is assumed that the inputs are known with certainty, i.e., the exact means (μ), variances or standard deviation (σ), and covariances (Σ).

Even for long-term returns, i.e. when the return is approximately normally distributed, the estimator for the return (μ) is problematic. For approximately normally distributed returns, the estimation of the covariances (Σ) is rather good (due to quadratic terms) but also provides a poor estimation for non-normal distributions. Thus, traditional optimization tends to overweight those assets having large statistical estimation errors associated with large estimated returns, small variances, and negative correlations, often resulting in poor ex-post performance. Thus, it is essential to take estimation errors into account for a more realistic portfolio optimization method. Due to the stylized facts of daily returns, normal distributions are not suitable. Since daily returns are not normally distributed, the estimation of the covariance matrix becomes problematic, too.

Modern methods of Bayesian portfolio optimization are discussed by Memmel, C., ‘Schätzrisiken in der Portfoliotheorie’, Ph.D. thesis, University of Cologne, 2004. The methods presented in this work are also based on the normal distribution assumption. In contrast, the article of Harvey, C. R. et al. (2004), ‘Portfolio selection with higher moments’, Duke University is based on a Bayesian decision theoretic framework that addresses two major shortcomings of the Markowitz approach: the ability to handle higher moments and uncertainties of the input parameters, i.e. estimation errors. The model of Harvey et al. considers the skew-normal distribution to allow for asymmetry and suggests to incorporate higher order moments in portfolio selection. The mean-variance utility function is extended by an additional skewness term. However, such skew-normal distributions do not allow for power law tails and the contribution of skewness to the utility function is rather arbitrary in that framework. It is hard to use alternative risk measures like Value at Risk (VaR) with said approach and the effects described in said article are most important for daily returns, but lose importance for longer investment horizons, such as monthly or quarterly periods.

In the U.S. Pat. No. 6,003,018 to Michaud et al., a method for evaluating an existing or putative portfolio having a plurality of assets is proposed. A mean-variance efficient portfolio is computed like in the classical Markowitz framework. In order to address any errors of the input parameters, the portfolio is computed for a plurality of simulations of input data which are statistically distributed around the expected return and expected standard deviation of return, and each such portfolio is associated, by means of an index, with a specified portfolio on the mean variance efficient frontier. A statistical mean of the index-associated mean-variance efficient portfolios is used for evaluating a portfolio for consistency with a specified risk objective. For re-sampling purposes, Michaud et al. draw the possible paths of different portfolio evolutions from distribution functions statistically consistent with some predefined expected returns and standard deviations. However, the meaning of the term ‘statistically consistent’ is not specified explicitly. In practice, the re-sampling procedure usually is based on the multivariate normal distribution where the sample mean vector and the sample covariance matrix are chosen as parameters. Moreover, since the weights of the portfolio are optimized by taking the average weights of certain mean-variance optimal portfolios the method may lead to unrealistic portfolios, i.e., it may happen that the optimization results in weights which do not fulfil one of the given external constraints of the portfolio. The return μ and the risk σ are the only input parameters.

For a further understanding of the method of the U.S. Pat. No. 6,003,018 and the differences of the present invention the portfolio evaluation and optimization will be further discussed in terms of a more mathematical notation.

The k-dimensional vector Θ denotes an arbitrary parameter vector. For instance, if X is a d-dimensional normally distributed random vector with mean μ and covariance matrix Σ, X˜N_{d}(μ,Σ), then Θ is the vector of the (stacked) elements of μ and Σ. The vector \hat{Θ} symbolizes an arbitrary estimator (but not the estimate) of Θ like, e.g., the (unrealized) elements of the sample mean vector and the sample covariance matrix.

Since the present invention will rely on the Bayesian framework both Θ and \hat{Θ} can be interpreted as random vectors. In contrast, the symbols θ and \hat{θ} stand for the realizations of Θ and \hat{Θ} (like x and y being the realizations of some random variables X and Y). The quantity ‘X|Y=y’ stands for a random vector which is distributed like X under the condition Y=y. This will be shortly written as X|y.

For notational convenience the distribution of a random vector X is denoted by p(x). Further, the distribution of the conditional random vector X|Y=y is symbolized by p(x|y). Hence, the Bayes rule can be simply written as

$$p ( x \vert y ) = \frac{p ( y \vert x ) \cdot p ( x )}{p ( y )} . \qquad ( 6 )$$

A sample of n observations of the d-dimensional random vector X is denoted by the d×n matrix x. It should be noted that each sample x uniquely determines the realization of \hat{Θ} but the converse is not true in general.

According to the approach of U.S. Pat. No. 6,003,018 an optimal weights function is determined. It is now supposed that w:R^{k}→R^{d} is the ‘optimal weights function’. That means w(θ) is the vector of optimal portfolio weights (according to a certain utility function and possibly by taking additional constraints into consideration) given the true parameter Θ. It is further supposed that \hat{Θ} is an unbiased estimator of Θ, i.e. the estimation is

E(\hat{Θ}|θ)=θ. (7)

Hence

w(E(\hat{Θ}|θ))=w(θ). (8)

It is further supposed that w is an affine function. Then the following equation holds:

w(θ)=w(E(\hat{Θ}|θ))=E(w(\hat{Θ}|θ)). (9)

The consequences of this assumption are pointed out with the following example. It is supposed that

$$w = \frac{{\sum }^{- 1} Δμ}{γ} \qquad ( 10 )$$

is the vector of optimal stock weights w₁, . . . , w_{d} (whereas the bond weight is given by w₀:=1−Σᵢ₌₁^{d}wᵢ) Here γ>0 symbolizes a risk aversion parameter, Δμ:=μ−r1 is the expected excess return with r being the risk-free interest rate, 1 is the d-dimensional vector of ones, and Σ is the covariance matrix of the returns. If Σ is assumed to be known then w is an affine function of μ.

For calculating the optimal weights vector one would try to simulate the distribution of \hat{Θ}|θ (see Eqs. (7) and (8)) in order to approximate E(w(\hat{Θ}|θ)). Of course, this cannot be done exactly since the true parameter θ is unknown. At this point the idea of U.S. Pat. No. 6,003,018 comes into play: The random vector \hat{Θ}|θ is approximated by the random vector \hat{Θ}|\hat{θ}, i.e. U.S. Pat. No. 6,003,018 re-samples the possible estimates \hat{θ} of Θ simply by drawing samples out of a population possessing the parameter \hat{θ}. Actually, according to this approach the optimal weights function is given by

w_{M}(\hat{θ}):=E(w(\hat{Θ}|\hat{θ}))=w(E(\hat{Θ}|\hat{θ}))=w(\hat{θ}). (11)

The latter expression is nothing else but the optimal weights vector given by the estimate \hat{θ}. Hence, in case of the above assumptions, i.e. w is an affine function, there is no need of re-sampling techniques. Only if w is not an affine function then w_{M}(\hat{θ})≠w(\hat{θ}), i.e. re-sampling would lead to another result than w(\hat{θ}).

If we now suppose that Σ from the previous example is not known, then w obviously is not an affine function anymore. Therefore it is questionable whether w_{M}(\hat{θ}) is the optimal solution of the portfolio optimization problem considering estimation errors. Even if one assumes that \hat{θ}=θ by chance (in fact, the probability that this equality is fulfilled exactly corresponds to zero), the weights principally cannot be optimal since due to the non-affine function

w_{M}(\hat{θ})=E(w(\hat{Θ}|θ))≠w(E(\hat{Θ}|θ))=w(θ). (12)

Of course, in practical situations \hat{θ} will always be different from θ. Though there may exist one estimate \hat{θ} such that the vector w_{M}(\hat{θ}) is the optimal solution of the portfolio optimization problem it can be expected that the weights generally are suboptimal or only optimal by chance, and the quality of the solution cannot be quantified. In summary, the approach of U.S. Pat. No. 6,003,018 provides only sufficient solutions for non-affine weight functions. However, in case the optimal weight function is non-affine then the weights as suggested in U.S. Pat. No. 6,003,018 generally are suboptimal.

Thus, the uncertainty estimation according to U.S. Pat. No. 6,003,018 is merely an approximation or guess, since the parameter uncertainty is done by simulating \hat{Θ}|\hat{θ}. However, a simulation of Θ|\hat{θ} would be more realistic and therefore desirable since \hat{Θ}|\hat{θ} (as done in U.S. Pat. No. 6,003,018) is generally not distributed like Θ|\hat{θ}. This problem will be solved with the method according to the present invention.

In summary, known portfolio optimization methods have the following drawbacks when estimation errors should be taken into account:

The return of a simple (discrete) return is not normally distributed but contains fatter or even heavy tails. In view of the asymmetric distributions of discrete returns of individual assets, mean and variance are insufficient for portfolio management purposes.

Mean estimation errors are already problematic for normally distributed returns and for normally distributed log-returns. For heavy tailed distributions also covariance matrix estimation becomes a problem like frequently observed in practice.

The use of historical simulations and back-testing is limited, in particular for long investment horizons due to the lack of observations over sufficient long periods, in particular back-testing ‘in-sample’ is inadmissible.

Also traditional return and risk measurements like, e.g., expected return and variance are inappropriate for dynamic portfolio optimization.

Traditional return and risk measurements are inappropriate for long investment horizons and non-linear financial instruments since the arising return distributions are typically asymmetric.

Furthermore, even continuous returns (log-returns) are not normally distributed but heavy tailed for short investment periods.

It is an object of the present invention to provide a robust portfolio evaluation and a portfolio optimization method which takes the presence of estimation errors into account. It is a further object to provide a portfolio evaluation and a portfolio optimization method for long investment horizons using dynamic portfolio strategies and/or non-linear financial instruments. It is a further object of the invention to avoid possible misspecifications due to wrong assumptions about the return distributions which is achieved by the use of the broad class of generalized elliptical distributions.

The objects of the invention are achieved with the features of the claims.

### SUMMARY OF THE INVENTION

According to a first aspect, in one of the embodiments there is provided a method for optimizing a portfolio with several financial instruments, the method comprising the steps of: a) selecting constraints and optimality criteria for the portfolio; b) obtaining historical information for financial risk factors; c) selecting an appropriate model for simulating the risk factors of the portfolio by way of an elliptical distribution; wherein the selection is based on the historical information; d) considering both estimation risk and market risk by simulation; e) selecting numerical accuracy criteria for the optimal portfolio composite; f) simulating the risk factors by drawing a plurality of parameters and paths given the model and the observation (—possibly containing missing values); g) finding the optimal portfolio weights given the selected constraints and optimality criteria on the basis of the parameters and paths simulated; h) proceeding the above simulation and finding of the optimal portfolio weights until said accuracy criteria are fulfilled.

According to a further aspect, in one of the embodiments there is provided a method for evaluation a portfolio with several financial instruments, the method comprising the steps of: a) providing weights for a given portfolio; a′) selecting evaluation criteria for the portfolio; b) obtaining historical information for financial risk factors; c) selecting an appropriate model for simulating the risk factors of the portfolio by way of an elliptical distribution; wherein the selection is based on the historical information; d) considering both estimation risk and market risk by simulation; e) selecting a numerical accuracy criteria for the given portfolio composite; f) simulating the risk factors by drawing parameters and paths given the model and the observation (—possibly containing missing values); g) evaluating the given portfolio by the selected evaluation criteria on the basis of the parameters and paths simulated; h) proceeding the above simulation and evaluation algorithm until said accuracy criteria are fulfilled.

In accordance with an exemplary embodiment, the elliptical distributions for simulating the risk factors (X) of said financial instruments are represented at least in terms of an expected return vector (μ), a dispersion matrix (Σ), a generating variate (R) and random vector (U).

In accordance with a further exemplary embodiment, the missing values are simulated by means of standard techniques of multiple imputation and/or data augmentation.

In accordance with a further exemplary embodiment,the data augmentation is performed for missing historical information and for unknown future values.

In accordance with a further exemplary embodiment, the data augmentation is based on a Gibbs sampler.

In accordance with a further exemplary embodiment,the realisation of the expected return vector (μ) and the realisation of the dispersion matrix (Σ) are posterior distributions obtained on the basis of said historical information and “a priori” information.

In accordance with yet a further exemplary embodiment, the a priori information is based on informative and/or non-informative priors.

In accordance with a further exemplary embodiment, the assessing in step g) is based on confidence intervals and hypothesis tests.

In accordance with a further exemplary embodiment, the posterior return parameter (μ) and the posterior dispersion matrix (Σ) are conditioned on estimators (\hat{μ}, \hat{Σ}) for the expected return parameter and the dispersion matrix.

In accordance with yet a further exemplary embodiment, the estimators (\hat{μ}, \hat{Σ}) for the expected return parameter and the dispersion matrix are affine equivariant estimators.

In accordance with a further exemplary embodiment, a joint posterior distribution of the expected return parameter (μ) and the dispersion matrix (Σ) is approximated.

In accordance with a further exemplary embodiment, the estimators for the expected return parameter (\hat{μ}) and the dispersion matrix (\hat{Σ}) are simulated by a matrix containing a d-dimensional random vectors uniformly distributed on a unit hypersphere (U:=[U₁ . . . Uₙ]) and a matrix containing the generating variates (R) on the main diagonal (R:=diag(R₁, . . . , Rₙ)).

In accordance with a further exemplary embodiment, the parameter of the generating variate (r) and/or the unit random vector (U) represent the market risk.

In accordance with a further exemplary embodiment, the parameter of the generating variate (R) and the expected return parameter (μ) with the dispersion matrix (Σ) can be simulated independently.

In accordance with a further exemplary embodiment, the posterior distribution of the dispersion matrix (Σ) is a product of a nonsigular matrix (Λ) and its transposed matrix (Λ′).

In accordance with a further exemplary embodiment, the posterior distributions of expected return and dispersion matrix (μ, Σ) are based on the estimators of the expected return and the dispersion matrix (\hat{Σ}).

In accordance with a further exemplary embodiment, the posterior distribution of the dispersion matrix (Σ) is simulated with the steps of: (i) simulating a random sample UR; where U:=[U₁ . . . Uₙ] is a matrix containing n columns of d-dimensional random vectors uniformly distributed on the unit hypersphere and R:=diag(R₁, . . . , Rₙ) contains n generating variates on the main diagonal; (ii) calculating the inverse of the estimator of the dispersion matrix (\hat{Σ}(UR)⁻¹), and (iii) multiplication of \hat{Λ} from the left and from the right.

In accordance with a further exemplary embodiment, the posterior distribution of the expected return (μ) is simulated after the simulation of the posterior distribution of the dispersion matrix (Σ) based on said simulated matrix (U) and the matrix containing the generating variates (R) on the main diagonal and the symmetric square root of the posterior distribution of the dispersion matrix (Σ).

In accordance with a further exemplary embodiment, the simulation of the risk factors by way of a vector X comprises the steps of: (i) simulating a realization of a posterior distribution of the dispersion matrix (Σ|(\hat{μ}, \hat{Σ})); (ii) simulating a realization of a posterior distribution of the return or location (μ|(\hat{μ}, \hat{Σ})) by taking the symmetric root of the realization of the posterior distribution of the dispersion matrix (Σ|\hat{Σ}) into account; (iii) simulating new realizations of the generating variate (R) and U^{(d)} to obtain a possible realizations of the vector X and (iv) calculating the corresponding trajectory or path of stock prices based on the estimates of the location, the dispersion matrix (\hat{μ}, \hat{Σ}) and the vector X. (v) repeating steps (i) to (iv) until there is a sufficiently large number of simulated trajectories which fulfill the predetermined accuracy criteria.

In accordance with a further exemplary embodiment, the optimization criteria is at least one of the group consisting of, optimization of an expected utility function, performance and risk measures like, e.g. Value at Risk (VaR), Return on Investment (RoI), shape ratio, and multi-objective decision criteria.

In accordance with one further embodiment of the present invention, a computer system is adapted for carrying out the above method steps.

In accordance with still a further embodiment of the present invention, a method for optimizing a portfolio comprising several financial instruments, comprising the steps of: a) selecting constraints and optimality criteria for the portfolio; b) obtaining historical information for financial risk factors; c) selecting an appropriate model for simulating the risk factors of the portfolio by way of an elliptical distribution and specifying the parameters of a generating variate (R) of said elliptical distribution; wherein the selection is based on the historical information; d) considering both estimation risk and market risk by simulation; e) selecting a numerical accuracy criteria for the optimal portfolio composite; f) finding affine equivariant estimators for a mean vector (μ) and covariance matrix (Σ); g) simulating the risk factors, wherein possible paths are simulated by way of the generating variate (R); h) generating possible realizations of the true covariance matrix and the true mean vector from the simulated sample errors by utilizing the equivariance property; i) computing possible paths of different portfolio evolutions using the mean and covariance parameters obtained in step g) j) simulating an portfolio outcome by drawing parameters and paths from the universe of models conditioned on the observations and the model; k) finding the optimal portfolio weights given the selected constraints and optimality criteria on the basis of the parameters and paths simulated; 1) proceeding the above resampling and optimization algorithm until numerical accuracy criteria are fulfilled.

The present invention is based on estimates obtained by historical data and searches for the optimal portfolio by the use of re-sampling techniques. In the following the term ‘re-sampling’ is used to describe a variety of methods for generating the stochastic processes of risk factors by means of Monte-Carlo (MC) simulation. In particular, the re-sampling method of the present invention distinguishes four kinds of risk sources:
(i) The market risk, i.e. the risk of an unfavorable development of the assets.
(ii) The model risk, i.e. the risk of using a wrong model.
(iii) The estimation risk, i.e. the risk that the estimates of the model parameters differ from their true values.
(iv) The numerical risk, i.e. the risk of an insufficient approximation of the true distributions of model parameters or using a suboptimal solution for the optimal portfolio.

Since in general multivariate log-returns are not normally distributed, the method according to the present invention parameterizes the log-returns using multivariate generalized elliptical distributions. It should be noted that the class of elliptical distributions is a natural generalization of the multivariate normal (or ‘Gaussian’) distribution function. Generalized elliptical distributions are a generalization of elliptically symmetric and skew-elliptical distributions that properly reflect observed asymmetries in financial return distributions. The class of multivariate generalized elliptical distributions comprises distributions consistent with the stylized facts of empirical finance, such as heavy tails and skewness. In addition to the normal distribution function many other well known and widely used multivariate distribution functions are elliptical too, e.g., the t-distribution, the symmetric generalized hyper-bolic distribution, and the sub-Gaussian a-stable distributions. The broad class of generalized elliptical distributions is further discussed in the Ph.D. thesis (2004) of G. Frahm, ‘Generalized elliptical distributions: theory and applications’, University of Cologne, which is herein incorporated by reference.

In other words, the method of the present invention is able to model more realistic distributions beyond the traditional Gaussian distribution hypothesis.

In the following, the present invention is not limited to portfolios which are based on stocks. Any other portfolio components such as bonds, options or other derivatives, certificates, commodities, indices, currencies or other tradable assets are allowed to form a portfolio according to the present invention.

The present invention allows to specify alternative models for the distribution of risk factors affecting portfolio development, which readily match empirical data, possibly supported by subjective considerations. Consequently, the optimal portfolio is a portfolio which predicts the greatest benefit to be expected for the given model. The model risk can be assessed by variation of the models. That is for a specific set of models the corresponding optimal portfolios are compared. In case the deviation of the optimal portfolios is large the model risk is large, too, and vice versa.

For a given portfolio (that is for the purpose of portfolio evaluation) confidence intervals concerning the model parameters, portfolio returns and other quantities can be derived. Further, one can perform hypothesis tests for certain critical null hypotheses, such as: the portfolio Value at Risk (VaR) is above a critical threshold; the expected portfolio return is smaller than the risk-free interest rate, or the expected utility is below a given critical value, etc.

According to the present invention, it is assumed that the risk factors are generalized elliptically distributed. The optimized portfolio of the present invention is achieved by optimizing an objective function over the full distribution of possible portfolio returns. Since the full distribution contains not only the market/innovation risk (i) but also the estimation risk (iii), the objective function is not necessarily formulated in terms of expected return and variance, like typically done by traditional methods. In other words, according to the present invention the market risk (i) and the estimation risk (iii) are considered in combination as will be discussed in further detail below.

According to the present invention, the estimation risk (iii) is simulated efficiently by using affine equivariant estimators for location and scatter. Stylized facts of empirical finance, like e.g. the occurrence of heavy tails, are considered by the choice of appropriate models (ii) for the risk factors.

An advantage of the present invention is the realistic consideration of estimation errors. As discussed above, the present invention provides a simulation of Θ|\hat{θ} instead of \hat{Θ}|\hat{θ}.

For taking estimation errors or, synonymously, parameter uncertainty into consideration, the distribution of Θ (i.e. the reality) under the observed data x, i.e. p(θ|x) is desired. This is called the ‘posterior distribution’ of Θ. In the Bayesian approach, knowledge about unknown quantities of interest, θ, is expressed by a prior probability distribution p(θ) and combined with empirical observations, x, by means of a likelihood function p(x|θ). The Bayes rule as already mentioned at (6) leads to the ‘posterior distribution’:

$$p ( θ \vert x ) = \frac{p ( x \vert θ ) \cdot p ( θ )}{p ( x )} . \qquad ( 13 )$$

The distribution of Θ, i.e. p(θ) generally is referred to as the prior or ‘a priori’ distribution. If there is no prior information at all then p(θ) is constant over the set of admissible values of θ and thus

$$p ( θ \vert x ) ∝ \frac{p ( x \vert θ )}{p ( x )} . \qquad ( 14 )$$

It should be noted that p(x) (called the ‘evidence’) is also a (positive) constant given the observation x. Thus, it can be assumed

p(θ|x)∝p(x|θ). (15)

### The function θp(x|θ) is called the ‘likelihood function’ of Θ and it is often simply denoted by L(θ).

Due to the proportionality given by (15) the likelihood function L(θ) may be utilized for simulating the posterior distribution of Θ, i.e. p(θ|x). The canonical approach is given by von Neumann's rejection method, more precisely by simulating N (large) (k+1)-dimensional random vectors Z=(ζ, ξ) (ζ ε R^{k}, ξ ε R), uniformly distributed on the rectangle

[−c, c]^{k}×[0, L(θ_{ML})], (16)

where c ε R is a large number and θ_{ML} denotes the maximum likelihood estimate of Θ, i.e.

$${θ}_{ML} = arg {max }_{θ} ℒ ( θ ) . \qquad ( 17 )$$

The random vector ζ=(ζ₁, . . . , ζₖ) can be interpreted as a potential outcome of Θ. If ξ>L(ζ) or one of the components ζ₁, . . . , ζₖ has no admissible value then the corresponding realization of Z is rejected. That is to say only the residual outcomes of Z are taken into consideration where each remaining vector ζ represents a realization of Θ.

Clearly, the rejection method is not efficient. The range of possible outcomes of Θ has to be restricted by a large number c since we are searching for estimation risk, i.e. assessing the probability of large deviations of Θ. But the larger c the more realizations of Z must be rejected, i.e. the described method quickly becomes inefficient. A fortiori this holds for large k, i.e. for complex models and/or high-dimensional data.

For that reason the present invention provides an efficient method for simulating the posterior distribution of Θ. Instead of quantifying the distribution of Θ given the observation x the method of the present invention aims at calculating the distribution of Θ given the parameter estimate \hat{θ}, i.e. p(θ|\hat{θ}). That is to say only the ‘essential’ information (regarding the parameter Θ) contained in x is utilized for deriving the desired distribution function. In the following we assume that there is no prior information about θ and thus

$$p ( θ \vert \hat{θ} ) = \frac{p ( \hat{θ} \vert θ ) \cdot p ( θ )}{p ( \hat{θ} )} ∝ p ( \hat{θ} \vert θ ) . \qquad ( 18 )$$

A further advantage of the present invention is that the method can be applied to arbitrary dynamic portfolio strategies under institutional or individual constraints. Further, the method can be applied even for the case of incomplete data, e.g. by means of data augmentation.

The evaluation and optimization method is preferably organized in a re-sampling or Monte Carlo procedure. In the following ‘portfolio evaluation’ means that different risk scenarios are derived from a given portfolio, whereas ‘portfolio optimization’ means that an optimal portfolio is derived from the view of different risk scenarios. Constraints, optimality criteria for the portfolio, and a desired accuracy (iv) are selected. Historical observations of risk factors are used as input data. These data are combined with the selected model, wherein the output of the method consists of parameters obeying the posteriori distribution of the model and corresponding scenarios for the future evolution of financial risk factors. On the basis of these realizations methods of portfolio evaluation and optimization are applied.

In the following the method of the present invention will be further described by way of mathematical examples.

According to a preferred embodiment of the present invention, the class of generalized elliptical distributions is considered for modeling the multivariate distributions of risk factors like, e.g., stock returns. In the following it is assumed for the sake of simplicity that the portfolio comprises different stocks. However, it should be pointed out that the present invention is not restricted to stock portfolios but it is possible to consider arbitrary financial instruments, whose underlying risk factors (e.g. interest rates, exchange rates, stock returns, stock index returns or implied volatilities) are generalized elliptically distributed. Generalized elliptical distributions are defined as follows.

It is assumed that the portfolio comprises d different stocks. The d-dimensional random vector X, which represents for example a random return vector for the d different stocks, is said to be ‘generalized elliptically distributed’ if and only if

X [symbol] μ+ΛRU^{(k)}, (19)

where U^{(k)} is a k-dimensional random vector uniformly distributed on the unit hypersphere, R is a random variable, μεR^{d}, ΛεR^{d×k}, and [symbol] means equal in distribution. The random variable R is called the ‘generating variate’ of X and Σ:=ΛΛ′ is its ‘dispersion matrix’ (Λ′ denotes the transposed matrix of Λ). In case R is non-negative and stochastically independent of U^{(k)}, X is called ‘elliptically symmetric distributed’ and provided its covariance matrix exists it is proportional to Σ. In the following it is assumed that k=d and r(Λ)=d. In that case the dispersion matrix Σ is positive definite.

The random vector X can be interpreted as the vector of daily log-returns of d stocks where μ is the vector of expected log-returns. The residual term ΛRU^{(d)} denotes the random deviation from the expectation where the quantity RU^{(d)} represents the market risk and μ and Λ are due to estimation risk. According to the present invention not only RU^{(d)} but also μ and Λ are simulated on the basis of the observed market data. Hence, both risks (i) and (iii) are considered simultaneously.

For the sake of simplicity it is supposed that X is an elliptical random vector of independent and identically distributed daily log-returns of d stocks. Hence for simulating daily log-returns considering parameter uncertainty not only the generating variate R and the unit random vector U^{(d)} have to be simulated but also the parameters μ and Σ give some estimates for location and scatter, say \hat{μ} and \hat{Σ}. More precisely, the method according to the present invention relies on Eq. 19 but considers μ and Σ as random quantities conditioned on \hat{μ} and \hat{Σ}, i.e. (μ, Σ)|(\hat{μ}, \hat{Σ}). That means, the conditional random quantities of the ‘truth’ (μ, Σ) dependent on the estimates (\hat{μ}, \hat{Σ}). In the following realizations of μ and Σ are denoted by μ₀ and Σ₀ respectively.

In the subsequent discussion the distribution of (μ, Σ)|(\hat{μ}, \hat{Σ}) will be referred to as the ‘posterior distribution’ of (μ, Σ) (see Eq. (13)). It should be noted that estimation errors are due to historical observations whereas the market risk (which is represented by RU^{(d)})results from future innovations. It is assumed that past realizations, future innovations, and model parameters are mutually independent. Hence, the market risk can be simulated independently from (\hat{μ}, \hat{Σ}) and (μ, Σ)|(\hat{μ}, \hat{Σ}).

For obtaining the posterior distribution of (μ, Σ) the method of the present invention preferably relies on the broad class of ‘affine equivariant estimators’ for location and/or scatter. The function L:R^{d×n}→R^{d} is called an ‘affine equivariant location functional’ if

L(a1′+By)=a+BL(y),

for any y ε R^{d×n}, a ε R^{d}, and nonsingular B ε R^{d×d} where 1′ denotes the d-dimensional transposed vector of ones. Further, the function S:R^{d×n}→R^{d×d} is called an ‘affine equivariant scatter functional’ if S(y) is positive definite for any y ε R^{d×n} with r(y)=d and

S(a1′+By)=BS(y)B′,

where a ε R^{d} and B ε R^{d×d} is a nonsingular matrix. The equivariance property guarantees that location and scatter of affine linearly transformed data can be estimated from the estimators for the original data. Examples for affine linear transforms are shifting, rotating or re-scaling the data.

In the following affine equivariance will be abbreviated by ‘a.e.’. If L is a.e. then \hat{μ}(X):=L(X) is called an ‘affine equivariant estimator for location’. Here X is a random matrix denoting the unrealized sample. Analogously, if S is a.e. then \hat{Σ}(X):=S(X) is an ‘affine equivariant estimator for scatter’. As an example, the well known sample mean

$$\overline{X} = \frac{1}{n} \cdot {\sum }_{j = 1}^{n} {X}_{j} \qquad ( 20 )$$

is an a.e. estimator for location and the well known sample covariance matrix

$$\frac{1}{n} \cdot {\sum }_{j = 1}^{n} {( {X}_{j} - \overline{X} )}^{2} \qquad ( 21 )$$

is an a.e. estimator for scatter.

In the following \hat{μ}(X) and \hat{Σ}(X) denote some a.e. estimators for location and scatter whereas \hat{μ}≡\hat{μ}(x) and \hat{Σ}≡\hat{Σ}(x) are the corresponding estimates given by a specific realization of X.

For generalized elliptically distributed data, the estimators \hat{μ}, \hat{Σ} can be expressed in terms of the unknown true parameters μ and Λ (where Σ=ΛΛ′) and the unknown random quantities U₁^{(d)}, . . . , Uₙ^{(d)} and R₁ , . . . , Rₙ. In fact, for the location the equation

\hat{μ}(X)=μ+Λ\hat{μ}(UR) (22)

is obtained where

U:=[U₁^{(d)} . . . Uₙ^{(d)}] (23)

is a matrix containing n columns of d-dimensional random vectors uniformly distributed on the unit hypersphere and

R:=diag(R₁, . . . , Rₙ) (24)

contains n generating variates on the main diagonal. Further, for the scatter estimator one obtains

\hat{Σ}(X)=Λ\hat{Σ}(UR)Λ′. (25)

It should be noted that the method of the present invention is not limited by the above examples and any a.e. estimator may be used by the present invention.

The estimates \hat{μ} and \hat{Σ} have to be considered so as to obtain the posterior distribution of (μ, Σ). Under the condition \hat{μ}(X)=\hat{μ} and \hat{Σ}(X)=\hat{Σ} Eq. 25 becomes

\hat{Σ}=(Λ\hat{Σ}(UR)Λ′|\hat{μ}, \hat{Σ}), (26)

whereas Eq. 22 leads to

\hat{μ}=(μ+Λ\hat{μ}(UR)|\hat{μ}, \hat{Σ}) (27)

under the same condition. Hence the left hand sides of these equations are known whereas both μ|(\hat{μ}, \hat{Σ}) and Λ|(\hat{μ}, \hat{Σ}) on the right hand sides are unknown and considered as random quantities. Note that the parameter μ depends on \hat{μ}(X) but due to the affine equivariance property of \hat{Σ}(•) the parameter Λ|\hat{Σ} does not depend on \hat{μ}(X), i.e.

$$( Λ \vert \hat{μ} , \hat{\sum } ) {=}^{d} ( Λ \vert \hat{\sum } ) . \qquad ( 28 )$$

Moreover, the realizations of the parameters on the right hand sides of Eq. 26 and Eq. 27 are reciprocal to the realizations of \hat{μ}(UR) and \hat{Σ}(UR). According to the present invention the joint posterior distribution of μ and Λ is approximated (which implies the posterior distribution of Σ=ΛΛ′) simply by simulating \hat{μ}(UR) and \hat{Σ}(UR). It should be noted that according to the method of the present invention no information about μ and Σ are needed for simulating UR. More precisely, UR is stochastically independent of μ and Σ.

Now, it is supposed that Γ is the symmetric root of \hat{Σ}(UR) (which is a random matrix) and \hat{Λ} is the symmetric root of \hat{Σ}(which is a fixed matrix), i.e. \hat{Σ}(UR)=ΓΓ, and \hat{Σ}=\hat{Λ}\hat{Λ}. In the following it is defined

(Λ|\hat{Σ}):=\hat{Λ}Γ⁻¹. (29)

The distribution of Γ does not depend on \hat{Σ}. Clearly, the posterior distribution of the dispersion matrix is given by

(Σ|\hat{Σ})=(ΛΛ′|\hat{Σ})=\hat{Λ}, Γ⁻¹(\hat{Λ}Γ⁻¹)′=\hat{Λ}(ΓΓ)⁻\hat{Λ}=\hat{Λ}\hat{Σ}(UR)⁻¹\hat{Λ}. (30)

### The random matrix \hat{Σ}(UR)⁻¹ can be interpreted as the matrix of estimation errors resulting from the scatter estimator \hat{Σ}(•).

The above is illustrated by the following example. It is supposed that the d-dimensional vector X is normally distributed with mean μ₀ and covariance matrix Σ₀, i.e. X˜N_{d}(μ₀, Σ₀). Further, it is assumed that \hat{Σ}(•) is the sample covariance matrix and the sample size is n>d+2. It should be noted that

(Σ|\hat{Σ})=(\hat{Λ}⁻¹\hat{Σ}(UR)\hat{Λ}⁻¹)⁻¹. (31)

### The random matrix nW, where W:=\hat{Λ}⁻¹\hat{Σ}(UR)\hat{Λ}⁻¹, is d-dimensional Wishart-distributed with parameter \hat{Σ}⁻¹ and n−1 degrees of freedom,

nW˜W_{d}(n−1, \hat{Σ}⁻¹).

### Thus n⁻¹W⁻¹ possesses a d-dimensional inverse Wishart-distribution with parameter \hat{Σ} and n−1 degrees of freedom which can be denoted by W_{d}⁻¹(n−1, \hat{Σ}). So one obtains the posterior distribution of the covariance matrix,

(Σ|\hat{Σ})=W⁻¹˜nW_{d}⁻¹(n−1, \hat{Σ}), (32)

such that in this case sampling from the posterior distribution is reduced to drawing from a Wishart distribution.

In the general case, the dispersion matrix Σ can be simulated in three steps:
1. Simulating the random sample UR where U and R are given by Eqs. (23) and (24).
2. Calculating the inverse of the scatter estimate, i.e. \hat{Σ}(UR)⁻¹.
3. Multiplication of \hat{Λ} from the left and from the right.

Now, using Eq. 27 one obtains

(μ|\hat{μ}, \hat{Σ})=(\hat{μ}−Λ\hat{μ}(UR)|\hat{Σ})=\hat{μ}−\hat{Λ}Γ⁻¹\hat{μ}(UR). (33)

Hence, the location vector μ is simulated based on the knowledge of both UR (which was already simulated for Σ) and \hat{Λ}Γ⁻¹ (i.e. the symmetric root of Σ|\hat{Σ}). Hence the term \hat{Λ}Γ⁻¹\hat{μ}(UR) represents the estimation error produced by the location estimator.

The above is illustrated by the following example for the case of normally distributed data. It is considered that the setting of the previous example holds and \hat{μ}(•) denotes the sample mean. It is known that

(μ|\hat{μ}, Σ₀)=N(\hat{μ}, Σ₀/n). (34)

That is to say the parameter μ is normally distributed provided the true covariance matrix Σ₀ is known. But if it is unknown one has to substitute Σ₀ by its estimate \hat{Σ} and one obtains the posterior distribution

p(μ|\hat{μ}, \hat{Σ})=∫p(μ|\hat{μ}, \hat{Σ}) dp(Σ|\hat{Σ}). (35)

It should be noted that p(Σ|\hat{Σ}) corresponds to the inverse Wishart distribution. It can be shown that μ|(\hat{μ}, \hat{Σ}) is multivariate t-distributed possessing the location vector \hat{μ} the dispersion matrix \hat{Σ}/(n−d), and having n−d degrees of freedom. Thus μ|(\hat{μ}, \hat{Σ}) has the covariance matrix

$$𝕍ar ( μ \vert \hat{μ} , \hat{\sum } ) = \frac{\hat{\sum }}{n - d - 2} , \qquad ( 36 )$$

whereas Var(μ|\hat{μ}, Σ₀)=Σ₀n. Thus covariance uncertainty may increase estimation risk regarding the location vector μ of high-dimensional data, tremendously.

Now, having the posterior distributions of μ|(\hat{μ}, \hat{Σ}) and Σ|(\hat{μ}, \hat{Σ}) one is able to simulate the distribution of the vector of log-returns X or other risk factors taking estimation risk into account. As an example for the simulation of risk factors corresponding to asset log-returns consider the re-sampling algorithm comprising the following steps:
1. Simulating a realization of Σ|(\hat{μ}, \hat{Σ}) as explained above.
2. Simulating a realization of μ|(\hat{μ}, \hat{Σ}) using the symmetric root of the realization of Σ|\hat{Σ} as explained above.
3. Simulating m new realizations of R and U^{(d)} so as to obtain m possible realizations of X|(\hat{μ}, \hat{Σ}) by

(Xⱼ|\hat{μ}, \hat{Σ})=(μ+ΛRⱼUⱼ^{(d)}|\hat{μ}, \hat{Σ}), j=1, . . . , m. (37)
(The realization of (μ, Σ)|(\hat{μ}, \hat{Σ}) obtained in the two steps before remains constant in this step.)
4. Calculating the corresponding trajectory of stock prices by

$${P}_{t} = {P}_{0} ⊙ exp ( {\sum }_{j = 1}^{t} {X}_{j} \vert \hat{μ} , \hat{\sum } ) , t = 1 , … , m , \qquad ( 38 )$$

where P₀ is the vector of initial stock prices and ‘⊙’ denotes component-wise multiplication (cf. Eq. (4)). Consequently, exp(•) is a vectorial version of the usual exponential function.
5. Repeating steps 1 to 4 until there is a sufficiently large number of simulated trajectories or paths.

As mentioned before R and U^{(d)} in step 3 are stochastically independent of (μ, Σ)|(\hat{μ}, \hat{Σ}). Of course, the number of realizations m depends on the length of the investment period which is given for evaluation or optimization purposes. For example, in case the investment period corresponds to 30 years. Each year contains 12·21=252 trading days, approximately. Then m=30·252=7560.

A simple extension of the algorithm above is to repeat steps 3 and 4 for multiple realizations of paths based on a single realization of (μ, Σ) .

Another alternative is to use Gibbs sampling for the joint realization of true parameters and trajectories. In this context, the algorithm comprises the following steps:
1. Simulating a realization of Σ|(\hat{μ}, \hat{Σ}) as explained above.
2. Simulating a realization of μ|(\hat{μ}, \hat{Σ}) using the symmetric root of the realization of Σ|\hat{Σ} as explained above.
3. Simulating the future data as described in step 3 of the previous algorithm.
4. Construct a new data set combining the historical and simulated future data and estimate location and scatter (i.e. calculate (\hat{μ}, \hat{Σ})) on the basis of the new data.
5. Repeat steps 1 to 3, always replacing the old realizations by the new ones in step 3.

This method yields one realization of μ, Σ and m possible realizations of X drawn from the predictive distribution

∫p(x|μ, Σ) dp(μ, Σ|\hat{μ}, \hat{Σ}).

The same method can be used for incomplete historical data. In that case, standard methods for multiple imputation, e.g., data augmentation, can be applied. For data augmentation, not only the future data, but also the missing part of the historical data is simulated in step 3.

Generally, the random vector X|(\hat{μ}, \hat{Σ}) belongs to another distribution family than X|(μ₀, Σ₀) and estimation errors not only affect the distribution family of X but also its covariance matrix. That is to say it can be expected that the variances (and covariances) of the components of X increase if μ₀ and Σ₀ are not known but have to be estimated beforehand.

In the example above, the distribution of the random vector X can be considered as normal, i.e., X˜N_{d}(μ₀, Σ₀). By virtue of Eq. 33 one obtains

$$\begin{matrix}( X \vert \hat{μ} , \hat{\sum } ) = ( \hat{μ} - Λ \hat{μ} ( UR ) + Λℛ {U}^{( d )} \vert \hat{μ} , \hat{\sum } ) \\ = ( \hat{μ} - Λ ( ℛ {U}^{( d )} - \hat{μ} ( UR ) ) \vert \hat{μ} , \hat{\sum } ) .\end{matrix}$$

Due to the normal distribution assumption one obtains

$$ℛ {U}^{( d )} - \hat{μ} ( UR ) ∼ {N}_{d} ( 0 , \frac{n + 1}{n} \cdot {I}_{d} ) . \qquad ( 39 )$$

Hence X|(\hat{μ}, \hat{Σ}) is d-variate t-distributed with location vector \hat{μ}, dispersion matrix (n+1)/(n−d)·\hat{Σ}, and n−d degrees of freedom. Its covariance matrix is given by

$$𝕍ar ( X \vert \hat{μ} , \hat{\sum } ) = \frac{n + 1}{n - d - 2} \cdot \hat{\sum } ,$$

which is usually larger than Var(X|μ₀, Σ₀)=Σ₀. Particularly, for high-dimensional portfolio optimization problems estimation risk has a considerable impact.

Generally, one must presume that R has a certain distribution called the ‘generating distribution’ of X. The generating distribution essentially determines the risk of extreme values and particularly the probability that extreme values occur simultaneously, which is the case, e.g., in a financial market crash. It has to be pointed out that the normal distribution is not a good choice for financial data due to the stylized facts of empirical finance. Hence the normal distribution assumption can be substituted by alternative assumptions regarding the generating variate R allowing for heavy tails. Then the parameters of the generating distribution have to be estimated before the re-sampling algorithm starts. For assessing the model risk, this procedure can be repeated for different parameters of the generating distribution and the resulting risk scenarios can be compared to each other. That is, for a specific set of alternative models and/or parameters the corresponding risk measures are compared. In case the deviation of the optimal portfolio is large the model risk is large, too, and vice versa.

The method according to the present invention provides several advantages over existing methods. In the following some preferred advantages are are briefly discussed.

The portfolio weights are not necessarily chosen among values between zero and one but also negative weights (i.e. short selling) are allowed. A short sale is the sale of a security that isn't owned by the seller, but that is promised to be delivered later.

The present invention is not limited on the μ-σ-optimization and other optimization criteria can be considered.

As discussed above, according to the present invention it is assumed that the risk factors are generalized elliptically distributed. The class of generalized elliptical distributions particularly contains the class of skew-elliptical and elliptically symmetric distributions, e.g., the multivariate Gaussian and sub-Gaussian distributions, multivariate t-distributions, the whole class of multivariate symmetric generalized hyperbolic distributions, and other distributions that are frequently considered in the financial literature and in practice.

A further advantage of the present invention is that a method is provided which takes account of unavoidable estimation errors due to limited empirical information.

Yet another advantage of the present invention is that the method reduces model risk through sensitivity analysis regarding different generalized elliptical distribution families and parameterizations.

Still another advantage of the present invention is that the method allows portfolio optimization and evaluation over the full range of possible generalized elliptical distributions consistent with observational data.

Still another advantage of the present invention is that the method performs optimization on the simulated paths rather than averaging over optimal portfolios and that the method can cope with missing historical data. Moreover, the present invention also provides methods for evaluating a given portfolio or strategy.

Portfolio evaluation means that from a given portfolio different risk scenarios are derived, whereas the portfolio optimization means that from the view of different risk scenarios an optimal portfolio is derived.

Other embodiments of the present invention will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention.

### BRIEF DESCRIPTION OF THE DRAWINGS

The present invention will be further described with reference to the accompanying drawings which exemplify preferred embodiments of the invention, and wherein the reference numerals correspond to steps of the method, and wherein:

FIG. 1 is a flow diagram showing a method of a re-sampling procedure for portfolio evaluation taking account of estimation errors.

FIG. 2 is a flow diagram showing a general method of a re-sampling procedure for portfolio optimization taking account of estimation errors.

FIG. 3 is a flow diagram showing a special variant of a re-sampling procedure for portfolio optimization taking account of estimation errors.

### DETAILED DESCRIPTION OF THE DRAWINGS

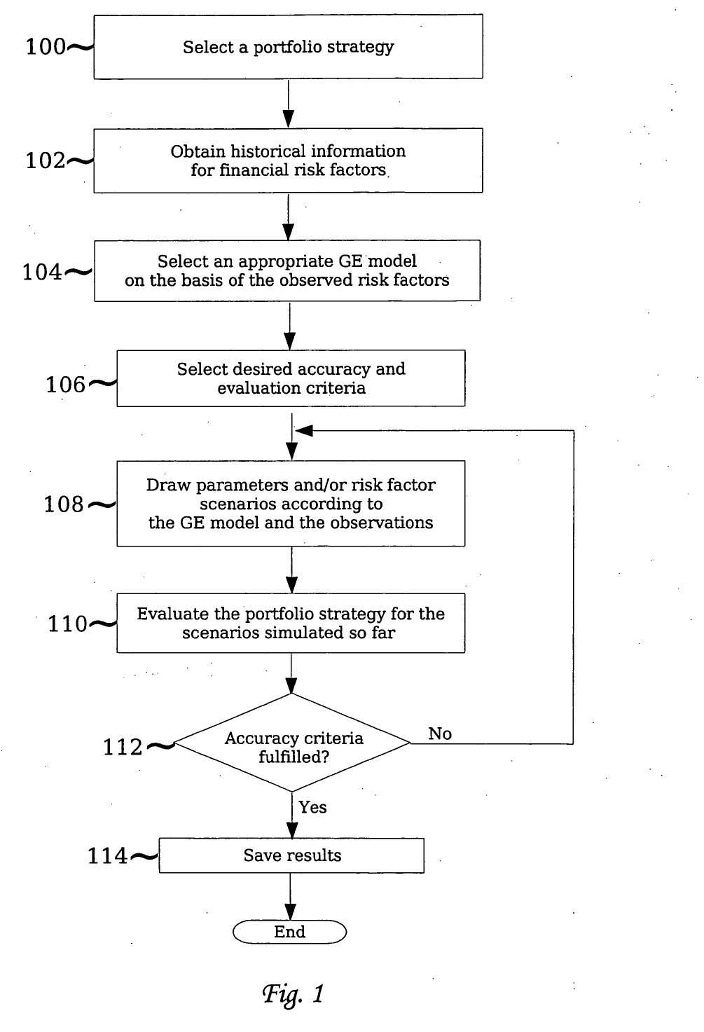

Referring to the drawings and in particular FIG. 1, one embodiment of a method, according to the present invention, of a re-sampling procedure for portfolio evaluation taking account of estimation errors is shown. The method is preferably to be carried out on a computer system that comprises a computer having a memory, a processor, a display and user input mechanism, such as a mouse or keyboard (not shown).

Description of FIG. 1:

FIG. 1 describes a method of a re-sampling procedure for portfolio evaluation taking account of estimation errors. The method of an exemplary embodiment comprises the following steps:
100 Select a portfolio strategy, i.e. some guidelines, behaviors or procedures concerning the construction and maintenance of an asset portfolio at any time during the investment period. The portfolio strategy is supposed to depend on some financial risk factors (see 102 below) and must be translated into an equivalent computer program or algorithm.
102 Obtain historical information for the financial risk factors of the selected portfolio strategy. The financial risk factors are the determinants of the value of the considered portfolio like, e.g., stock prices, interest rates, foreign exchange rates, prices of commodities, real estates, etc.
104 Select an appropriate GE model by considering the particular statistical properties of the collected data for financial risk factors. For instance, the results of statistical investigation may suggest that it is appropriate to use a heavy tailed generating distribution function producing a skew multivariate distribution of financial risk factors.
206 Select the evaluation criteria for the portfolio strategy. For evaluating the portfolio strategy any measure which is calculated by means of the portfolio value evolution can be considered. For instance, the expected value, the variance, the Sharpe ratio, the Value-at-Risk, etc. of the overall return on investment. Also measures considering the posteriori distribution of the parameters like, e.g., the variance of the true expected portfolio return or the probability that the true expected portfolio return is smaller than the risk-free interest rate, etc., can be applied. Moreover, measures which consider the meantime evolution of the portfolio value like, e.g., the probability that the portfolio value becomes smaller than a critical threshold during the investment period, etc., may be considered. Then select the accuracy criteria, e.g. the desired confidence intervals for the evaluation criteria.
108 Simulate the parameters and/or risk factor scenarios according to the GE model and the observations of the financial risk factors by the methods described in the present invention. For instance, data augmentation or other methods of multiple imputation can be applied if some observations of financial risk factors are missing. By multiple imputation not only past but also future evolutions of the financial risk factors can be simulated. The past evolutions can be used to fill in the missing data whereas the future evolutions can be used for calculating the possible portfolio evolvements during the investment period due to the selected portfolio strategy.
110 Evaluate the portfolio strategy for the parameters and/or risk factor scenarios simulated in step 108. This is done by using the evaluation criteria selected in step 106.
112 Check if the desired accuracy (see step 106) for the selected evaluation criteria is satisfied. If not, go back to step 108, otherwise go to step 114.
114 Save results and go to the end.
end The end of the re-sampling procedure may consist of a written summary, graphs or detailed descriptions concerning the input and output variables, evaluation criteria, simulated risk factor scenarios, posterior distributions, etc., preferably by the use of a computer display and/or printer.

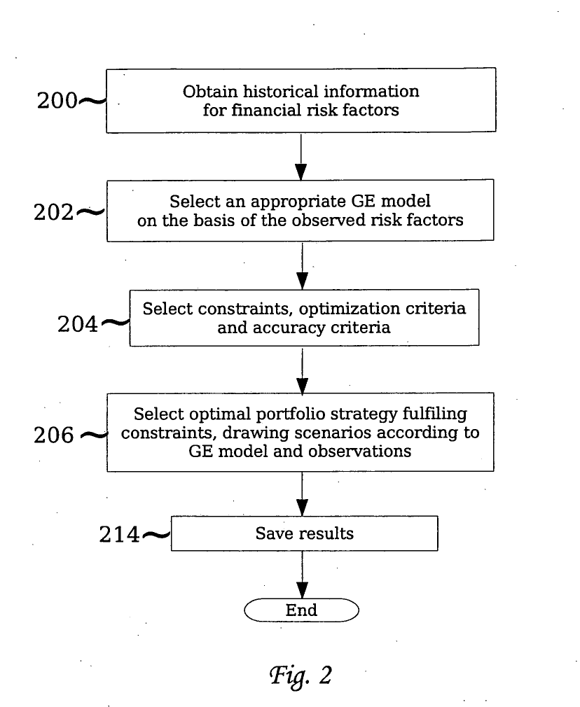

Description of FIG. 2:

FIG. 2 describes a method of a re-sampling procedure for portfolio optimization taking account of estimation errors. The method of an exemplary embodiment comprises the following steps:
200 Obtain historical information for financial risk factors. The financial risk factors are the determinants of the value of the considered portfolios like, e.g., stock prices, interest rates, foreign exchange rates, prices of commodities, real estates, etc.
202 Select an appropriate GE model by considering the particular statistical properties of the collected data for financial risk factors. For instance, the results of statistical investigation may suggest that it is appropriate to use a heavy tailed generating distribution function producing a skew multivariate distribution of financial risk factors.
204 Select constraints for the optimal portfolio strategy. That is specify an admissible set of guidelines, behaviors or procedures concerning the construction and maintenance of an asset portfolio according to individual preferences, institutional constraints, and/or restrictions given by law and economy. Further, select the optimization criteria, i.e. the criteria for searching the optimal portfolio strategy among all admissible portfolio strategies. For example, any portfolio evaluation criteria (see step 106) could serve as well as portfolio optimization criteria. Then select the accuracy criteria, e.g. the desired confidence intervals for the optimization criteria.
206 Simulate the parameters and/or risk factor scenarios according to the GE model and the observations of the financial risk factors by the methods described in the present invention and find the optimal portfolio strategy according to the optimization criteria specified in step 204. For instance, the optimal portfolio strategy can be searched by global optimization methods like, e.g., simulated annealing or genetic algorithms. Guarantee that both the selected constraints and the accuracy criteria (see step 204) are fulfilled.
214 Save results and go to the end.
end The end of the re-sampling procedure may consist of a written summary, graphs or detailed descriptions concerning the optimal portfolio strategy, input and output variables, optimization criteria, simulated risk factor scenarios, posterior distributions, etc., preferably by the use of a computer display and/or printer.

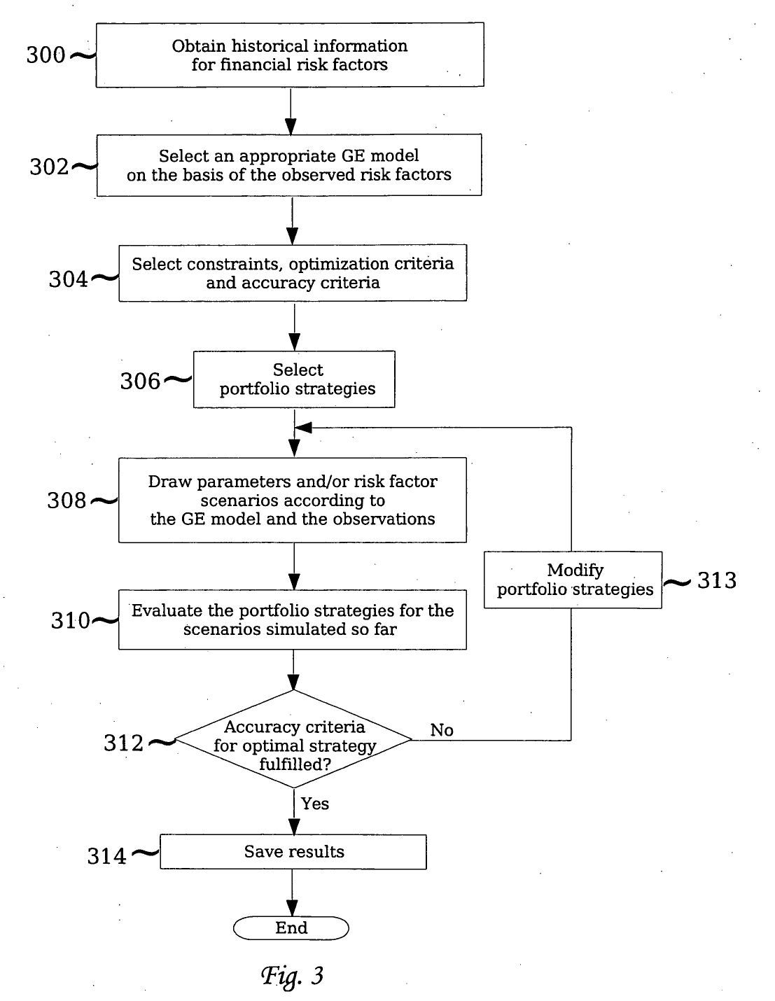

Description of FIG. 3:

FIG. 3 describes a special variant of a re-sampling procedure for portfolio optimization taking account of estimation errors. The method of an exemplary embodiment comprises the following steps:
300 Obtain historical information for financial risk factors. The financial risk factors are the determinants of the value of the considered portfolios like, e.g., stock prices, interest rates, foreign exchange rates, prices of commodities, real estates, etc.
302 Select an appropriate GE model by considering the particular statistical properties of the collected data for financial risk factors. For instance, the results of statistical investigation may suggest that it is appropriate to use a heavy tailed generating distribution function producing a skew multivariate distribution of financial risk factors.
304 Select constraints for the optimal portfolio strategy. That is specify an admissible set of guidelines, behaviors or procedures concerning the construction and maintenance of an asset portfolio according to individual preferences, institutional constraints, and/or restrictions given by law and economy. Further, select the optimization criteria, i.e. the criteria for searching the optimal portfolio strategy among all admissible portfolio strategies. For example, any portfolio evaluation criteria (see step 106) could serve as well as portfolio optimization criteria. Then select the accuracy criteria, e.g. the desired confidence intervals for the optimization criteria.
306 Select a set of admissible portfolio strategies.
308 Simulate the parameters and/or risk factor scenarios according to the GE model and the observations of the financial risk factors by the methods described in the present invention.
310 Evaluate the portfolio strategies for the scenarios simulated so far by the the portfolio optimization criteria selected in step 304.
312 Find the optimal portfolio strategy and guarantee that the selected constraints (see step 304) are fulfilled. If the accuracy criteria (see step 304) are not satisfied go to step 313, otherwise go to step 314.
313 Modify the set of portfolio strategies and go back to step 308.
314 Save results and go to the end.
end The end of the re-sampling procedure may consist of a written summary, graphs or detailed descriptions concerning the optimal portfolio strategy, input and output variables, optimization criteria, simulated risk factor scenarios, posterior distributions, etc., preferably by the use of a computer display and/or printer.

In alternative embodiments the method of the present invention may be implemented as a computer program product for use with a computer system. Such an implementation may comprise a plurality of computer instructions stored on a computer readable medium like a diskette, CD-ROM, ROM, or fixed disk or transmittable to a computer system via a network. The plurality of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation, preloaded with a computer system or distributed from a server or electronic bulletin board over the network. Of course, some embodiments of the invention may be implemented as a combination of both software (e.g., a computer program product) and hardware.

Still other embodiments of the invention are implemented as entirely hardware, or entirely software (e.g., a computer program product).

The present invention is realized by the features of the claims and any obvious modifications thereof. It is in no way intended to limit the scope or spirit of the invention as described above or set out in the claims.

1. A method for optimizing a portfolio with several financial instruments, the method comprising the steps of:
a) selecting constraints and optimality criteria for the portfolio;
b) obtaining historical information for financial risk factors;
c) selecting an appropriate model for simulating the risk factors of the portfolio by way of an elliptical distribution; wherein the selection is based on the historical information;
d) considering both estimation risk and market risk by simulation;
e) selecting numerical accuracy criteria for the optimal portfolio composite;
f) simulating the risk factors by drawing a plurality of parameters and paths given the model and the observation (—possibly containing missing values);
g) finding the optimal portfolio weights given the selected constraints and optimality criteria on the basis of the parameters and paths simulated;
h) proceeding the above simulation and finding of the optimal portfolio weights until said accuracy criteria are fulfilled.

2. A method for evaluation a portfolio with several financial instruments, the method comprising the steps of:
a) providing weights for a given portfolio;
a′) selecting evaluation criteria for the portfolio;
b) obtaining historical information for financial risk factors;
c) selecting an appropriate model for simulating the risk factors of the portfolio by way of an elliptical distribution; wherein the selection is based on the historical information;
d) considering both estimation risk and market risk by simulation;
e) selecting a numerical accuracy criteria for the given portfolio composite;
f) simulating the risk factors by drawing parameters and paths given the model and the observation (—possibly containing missing values);
g) evaluating the given portfolio by the selected evaluation criteria on the basis of the parameters and paths simulated;
h) proceeding the above simulation and evaluation algorithm until said accuracy criteria are fulfilled.

3. The method according to claim 1, wherein the elliptical distributions for simulating the risk factors (X) of said financial instruments are represented at least in terms of an expected return vector (μ), a dispersion matrix (Σ), a generating variate (R) and random vector (U).

4. The method according to claim 2, wherein the elliptical distributions for simulating the risk factors (X) of said financial instruments are represented at least in terms of an expected return vector (μ), a dispersion matrix (Σ), a generating variate (R) and random vector (U).

5. The method according to claim 1, wherein said missing values are simulated by means of standard techniques of multiple imputation and/or data augmentation.

6. The method according to claim 2, wherein said missing values are simulated by means of standard techniques of multiple imputation and/or data augmentation.

7. The method according to claim 5, wherein the data augmentation is performed for missing historical information and for unknown future values.

8. The method according to claim 6, wherein the data augmentation is performed for missing historical information and for unknown future values.

9. The method according to claim 5, wherein the data augmentation is based on a Gibbs sampler.

10. The method according to claim 6, wherein the data augmentation is based on a Gibbs sampler.

11. The method according claim 3, wherein the realisation of the expected return vector (μ) and the realisation of the dispersion matrix (Σ) are posterior distributions obtained on the basis of said historical information and “a priori” information.

12. The method according claim 4, wherein the realisation of the expected return vector (μ) and the realisation of the dispersion matrix (Σ) are posterior distributions obtained on the basis of said historical information and “a priori” information.

13. The method according to claim 11, wherein the a priori information is based on informative and/or non-informative priors.

14. The method according to claim 12, wherein the a priori information is based on informative and/or non-informative priors.

15. The method according to claim 2, wherein the assessing in step g) is based on confidence intervals and hypothesis tests.

16. The method according to claim 11, wherein the posterior return parameter (μ) and the posterior dispersion matrix (Σ) are conditioned on estimators (\hat{μ}, \hat{Σ}) for the expected return parameter and the dispersion matrix.

17. The method according to claim 12, wherein the posterior return parameter (μ) and the posterior dispersion matrix (Σ) are conditioned on estimators (\hat{μ}, \hat{Σ}) for the expected return parameter and the dispersion matrix.

18. The method according to claim 16, wherein the estimators (\hat{μ}, \hat{Σ}) for the expected return parameter and the dispersion matrix are affine equivariant estimators.

19. The method according to claim 17, wherein the estimators (\hat{μ}, \hat{Σ}) for the expected return parameter and the dispersion matrix are affine equivariant estimators.

20. The method according to claim 2, wherein a joint posterior distribution of the expected return parameter (μ) and the dispersion matrix (Σ) is approximated.

21. The method according to claim 16, wherein the estimators for the expected return parameter (\hat{μ}) and the dispersion matrix (\hat{Σ}) are simulated by a matrix containing a d-dimensional random vectors uniformly distributed on a unit hypersphere (U:=[U₁ . . . Uₙ]) and a matrix containing the generating variates (R) on the main diagonal (R:=diag(R₁, . . . , Rₙ)).

22. The method according to claim 17, wherein the estimators for the expected return parameter (\hat{μ}) and the dispersion matrix (\hat{Σ}) are simulated by a matrix containing a d-dimensional random vectors uniformly distributed on a unit hypersphere (U:=[U₁ . . . Uₙ]) and a matrix containing the generating variates (R) on the main diagonal (R:=diag(R₁, . . . , Rₙ)).

23. The method according to any of claims 1, wherein the parameter of the generating variate (R) and/or the unit random vector (U) represent the market risk.

24. The method according to any of claims 2, wherein the parameter of the generating variate (R) and/or the unit random vector (U) represent the market risk.

25. The method according to any of claim 1, wherein the parameter of the generating variate (R) and the expected return parameter (μ) with the dispersion matrix (Σ) can be simulated independently.

26. The method according to any of claim 2, wherein the parameter of the generating variate (R) and the expected return parameter (μ) with the dispersion matrix (Σ) can be simulated independently.

27. The method according to claim 3, wherein the posterior distribution of the dispersion matrix (Σ) is a product of a nonsigular matrix (Λ) and its transposed matrix (Λ′).

28. The method according to claim 4, wherein the posterior distribution of the dispersion matrix (Σ) is a product of a nonsigular matrix (Λ) and its transposed matrix (Λ′).

29. The method according to claim 11, wherein the posterior distributions of expected return and dispersion matrix (μ, Σ) are based on the estimators of the expected return and the dispersion matrix (\hat{Σ}).

30. The method according to claim 12, wherein the posterior distributions of expected return and dispersion matrix (μ, Σ) are based on the estimators of the expected return and the dispersion matrix (\hat{Σ}).

31. The method according to claim 11, wherein the posterior distribution of the dispersion matrix (Σ) is simulated with the steps of:
(i) simulating a random sample UR; where U:=[U₁ . . . Uₙ] is a matrix containing n columns of d-dimensional random vectors uniformly distributed on the unit hypersphere and R:=diag(R₁, . . . , Rₙ) contains n generating variates on the main diagonal;
(ii) calculating the inverse of the estimator of the dispersion matrix (\hat{Σ}(UR)⁻¹), and
(iii) multiplication of \hat{Λ} from the left and from the right.

32. The method according to claim 12, wherein the posterior distribution of the dispersion matrix (Σ) is simulated with the steps of:
(i) simulating a random sample UR; where U:=[U₁ . . . Uₙ] is a matrix containing n columns of d-dimensional random vectors uniformly distributed on the unit hypersphere and R:=diag(R₁, . . . , Rₙ) contains n generating variates on the main diagonal;
(ii) calculating the inverse of the estimator of the dispersion matrix (\hat{Σ}(UR)⁻¹), and
(iii) multiplication of A from the left and from the right.

33. The method according to claim 11, wherein the posterior distribution of the expected return (μ) is simulated after the simulation of the posterior distribution of the dispersion matrix (Σ) based on said simulated matrix (U) and the matrix containing the generating variates (R) on the main diagonal and the symmetric square root of the posterior distribution of the dispersion matrix (Σ).

34. The method according to claim 12, wherein the posterior distribution of the expected return (μ) is simulated after the simulation of the posterior distribution of the dispersion matrix (Σ) based on said simulated matrix (U) and the matrix containing the generating variates (R) on the main diagonal and the symmetric square root of the posterior distribution of the dispersion matrix (Σ).

35. The method according to claim 3, wherein the simulation of the risk factors by way of a vector X comprises the steps of:
(i) simulating a realization of a posterior distribution of the dispersion matrix (Σ|\hat{μ}, \hat{Σ}));
(ii) simulating a realization of a posterior distribution of the return or location (μ|\hat{μ}, \hat{Σ})) by taking the symmetric root of the realization of the posterior distribution of the dispersion matrix (Σ|\hat{Σ}) into account;
(iii) simulating new realizations of the generating variate (R) and U^{(d)} to obtain a possible realizations of the vector X and
(iv) calculating the corresponding trajectory or path of stock prices based on the estimates of the location, the dispersion matrix (\hat{μ}, \hat{Σ}) and the vector X.
(v) repeating steps (i) to (iv) until there is a sufficiently large number of simulated trajectories which fulfill the predetermined accuracy criteria.

36. The method according to claim 4, wherein the simulation of the risk factors by way of a vector X comprises the steps of:
(i) simulating a realization of a posterior distribution of the dispersion matrix (Σ|(\hat{μ}, \hat{Σ}));
(ii) simulating a realization of a posterior distribution of the return or location (μ|(\hat{μ}, \hat{Σ})) by taking the symmetric root of the realization of the posterior distribution of the dispersion matrix (Σ|\hat{Σ}) into account;
(iii) simulating new realizations of the generating variate (R) and U^{(d)} to obtain a possible realizations of the vector X and
(iv) calculating the corresponding trajectory or path of stock prices based on the estimates of the location, the dispersion matrix (\hat{μ}, \hat{Σ}) and the vector X.
(v) repeating steps (i) to (iv) until there is a sufficiently large number of simulated trajectories which fulfill the predetermined accuracy criteria.

37. The method according to claim 1, wherein the optimization criteria is at least one of the group consisting of, optimization of an expected utility function, performance and risk measures like, e.g. Value at Risk (VaR), Return on Investment (RoI), shape ratio, and multi-objective decision criteria.

38. The method according to claim 2, wherein the optimization criteria is at least one of the group consisting of, optimization of an expected utility function, performance and risk measures like, e.g. Value at Risk (VaR), Return on Investment (RoI), shape ratio, and multi-objective decision criteria.

39. A computer system for carrying out the method according to claims 1.

40. A computer system for carrying out the method according to claims 2.

41. A storage medium for storing a computer program to accomplish the method according to claim 1.

42. A storage medium for storing a computer program to accomplish the method according to claim 2.

43. A method for optimizing a portfolio comprising several financial instruments, the method comprising the steps of:
a) selecting constraints and optimality criteria for the portfolio;
b) obtaining historical information for financial risk factors;
c) selecting an appropriate model for simulating the risk factors of the portfolio by way of an elliptical distribution and specifying the parameters of a generating variate (R) of said elliptical distribution ; wherein the selection is based on the historical information;
d) considering both estimation risk and market risk by simulation;
e) selecting a numerical accuracy criteria for the optimal portfolio composite;
f) finding affine equivariant estimators for a mean vector (μ) and covariance matrix (Σ);
g) simulating the risk factors, wherein possible paths are simulated by way of the generating variate (R);
h) generating possible realizations of the true covariance matrix and the true mean vector from the simulated sample errors by utilizing the equivariance property;
i) computing possible paths of different portfolio evolutions using the mean and covariance parameters obtained in step g)
j) simulating an portfolio outcome by drawing parameters and paths from the universe of models conditioned on the observations and the model;
k) finding the optimal portfolio weights given the selected constraints and optimality criteria on the basis of the parameters and paths simulated;
l) proceeding the above resampling and optimization algorithm until numerical accuracy criteria are fulfilled.
